(19) United States
(12) Patent Application Publication
(10) Pub. No.: US 2013/0250510 A1
(43) Pub. Date: Sep. 26, 2013

(54) Tablet PC Case with Built-in Mini Printer

(71) Applicant: Keno Andutan, New South Wales (AU)

(72) Inventor: Keno Andutan, New South Wales (AU)

(21) Appl. No.: 13/675,364

(22) Filed: Nov. 13, 2012

(30) Foreign Application Priority Data
Mar. 26, 2012 (CN) 201220117658.7

(51) Int. Cl. G06F 1/16

(52) U.S. Cl. CPC G06F 1/1628
USPC 361/679.56

(57) ABSTRACT

The present application relates generally to tablet PC cases. Specifically, this application relates to a tablet PC case with built-in printer.

### FIELD OF THE INVENTION

The present application relates generally to tablet PC cases. Specifically, this application relates to a tablet PC case with built-in printer.

### CROSS-REFERENCE TO RELATED APPLICATIONS

This application claims the benefit of People's Republic of China Patent Application No. 201220117658.7 filed Mar. 26, 2012, the entire disclosure of which is incorporated herein by reference.

### BACKGROUND

As tablet PCs are becoming increasingly popular, the population using tablet PCs are increasing. To avoid PCs being damaged during use and moving, a great variety of PC cases have been developed. Though current tablet PC cases play an active role in protecting tablet PCs, they are still being denounced for single function, especially when people want to print photos, pictures and words saved in the tablet PC; as this operation requires the provision of an additional printer, it brings inconvenience in use and carry.

Therefore, there is a need in the art for a tablet PC case with a built-in printer. These and other features and advantages of the present invention will be explained and will become obvious to one skilled in the art through the summary of the invention that follows.

### SUMMARY OF THE INVENTION

Accordingly, it is an aspect of the present invention to provide a tablet PC case with built-in printer which functions not only to protect the tablet PC from being damaged also to print what is saved therein.

According to an embodiment of the present invention, a tablet PC case with built-in printer includes: a base, a upper frame, a cover, two side boards, and a printer, wherein the front side of the base folds a front edge and the back side of the base folds a back edge; the upper frame is attached to the base, whose connection between them is achieved in a removable way; the upper frame has a screen window in the middle for the tablet PC; the front side of the upper frame has a folded edge I; the cover is attached to the upper frame; two side boards are mounted on the upper frame and the left and right sides of the base respectively, whose connections between them are also achieved in a removable way; and the printer consists of a circuit board and a print head, both of which are mounted on the base.

According to an embodiment of the present invention, the tablet PC case with built-in printer, the upper frame has an opening to receive the home button of the tablet PC.

According to an embodiment of the present invention, the tablet PC case with built-in printer, a front groove is provided on the front side of the base and a rear groove is provided on the back side of the base, wherein the circuit board of the printer is mounted in the front groove of the base while the print head thereof is mounted in the rear groove

According to an embodiment of the present invention, the tablet PC case with built-in printer, a print-out groove is provided on the folded edge I of the upper frame front side.

According to an embodiment of the present invention, the tablet PC case with built-in printer, a hinge connection is used between the cover and the upper frame.

According to an embodiment of the present invention, the tablet PC case with built-in printer, the hinge connection between the cover and the upper frame is of folding hinge type, wherein either end of the back side of the cover is provided with an arm extension on which there is a hinge recess, either end of the back side of the upper frame is provided with a lug on which there is a hinge protruding part, and the hinge recess perfectly matches with the hinge protruding part.

According to an embodiment of the present invention, the tablet PC case with built-in printer, a folded edge II is provided on the front side of the cover.

Compared with current tablet PC cases, the present Utility Model has the function in protecting the tablet PC, avoiding it being damaged, and the function of the printer as well, which provides the convenience in printing photos, pictures, and words saved in the tablet PC.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a perspective view of a tablet PC case with built-in printer, in accordance with an embodiment of the present invention.

FIG. 2 is a perspective view of a tablet PC case with built-in printer, in accordance with an embodiment of the present invention.

FIG. 3 is a rear view of a tablet PC case with built-in printer, in accordance with an embodiment of the present invention.

FIG. 4 is a front view of a tablet PC case with built-in printer, in accordance with an embodiment of the present invention.

FIG. 5 is a perspective view of a tablet PC case with built-in printer, in accordance with an embodiment of the present invention.

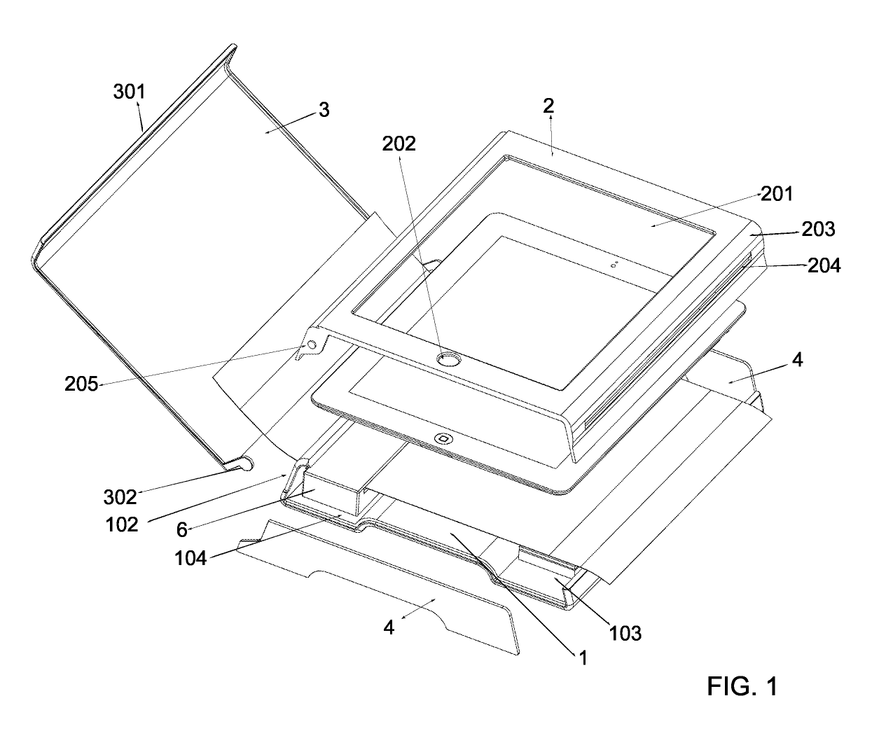

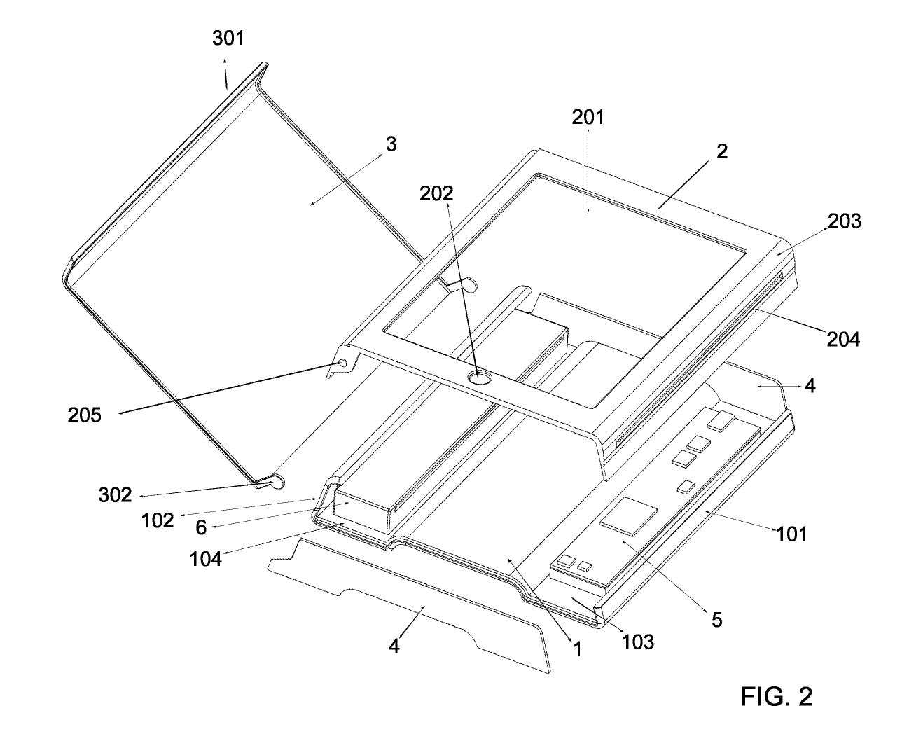

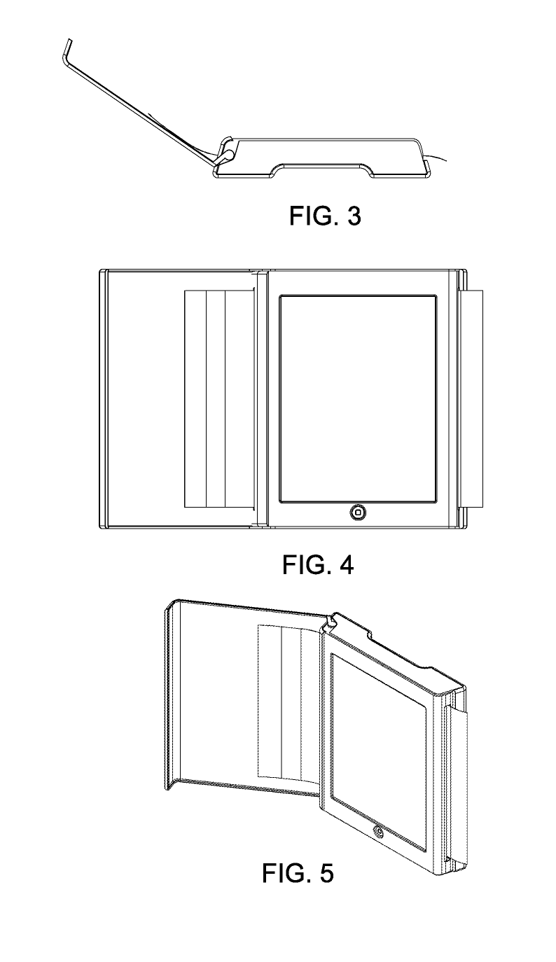

In FIG. 1 through 5, 1 means the base, 101 the front folded edge, 102 the rear folded edge, 103 the front groove, and 104 the rear groove; 2 indicates the upper frame, 201 the screen window for the tablet PC, 202 the button home of the tablet PC, 203 the folded edge I, 204 the print-out groove, 205 the lug, and 206 the hinge protruding part; 3 indicates the cover, 301 the folded edge II, 302 the arm extension, and 303 the hinge recess; 4 is the side board; 5 is the circuit board; and 6 is the print head.

### DETAILED DESCRIPTION

By referring to the drawings, future illustrations are made to the present Utility Model through the preferred embodiment.

With reference to FIG. 1 through 5, a tablet PC case with built-in printer, consisting a base 1, a upper frame 2, a cover 3, two side boards 4, and a printer, wherein:

The base 1 has a front folded edge 101 on the front side and a rear folded edge 102 on the back side, and has a front groove 103 on the front end and a rear groove 104 on the rear end;

The upper frame 2 has a screen window 201 in the middle for the tablet PC, an opening 202 to receive the home button of the tablet PC, and a folded edge I 203 on the front side, in which a print-out groove 204 is designed; the upper frame 2 is attached to the base 1 via a removable connection;

The cover 3 has a folded edge II 301 on the front side; the cover 3 is attached to the upper frame 2; two side boards 4 are mounted on the upper frame 3 and the right and left sides of the base 1 respectively; the side boards 4 are connected to the upper frame 2 and the base 1 respectively in a removable way;

The printer consists of the circuit board 5 and the printer head 6, wherein the circuit board 5 of the printer is installed into the front groove 103 of the base 1 and the print head 6 is installed into the rear groove 104 of the base 1;

A fold hinge connection is used between the cover 3 and the upper frame 2, wherein either end of the back side of the cover 3 is provided with an arm extension 302 on which there is a hinge recess 303, either end of the back side of the upper frame 2 is provided with a lug 205 on which there is a hinge protruding part 206, and the hinge recess 203 perfectly matches with the hinge protruding part 206.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A tablet PC case with built-in printer, said tablet PC case with built-in printer comprising:
a base;
an upper frame;
a cover;
two side boards; and a printer,
wherein the front side of the base folds a front edge and the back side of the base folds a back edge, the upper frame is attached to the base, whose connection between them is achieved in a removable way; the upper frame has a screen window in the middle for the tablet PC; the front side of the upper frame has a folded edge I; the cover is attached to the upper frame; two side boards are mounted on the upper frame and the left and right sides of the base respectively, whose connections between them are also achieved in a removable way; and the printer consists of a circuit board and a print head, both of which are mounted on the base.

2. The tablet PC case with built-in printer of claim 1, wherein the upper frame is provided with an opening for tablet PC home button.

3. The tablet PC case with built-in printer of claim 1, wherein the base has a groove on the front side and a groove on the back side, wherein the circuit board of the printer is mounted in the front groove while the print head of the printer is mounted on the rear groove.

4. The tablet PC case with built-in printer of claim 1, wherein the edge fold on the front side of the upper frame has a paper-out groove.

5. The tablet PC case with built-in printer of claim 1, where in the front side of the cover is provided with an edge fold II.

6. The tablet PC case with built-in printer of claim 1, wherein hinges are used for connection between the cover and the upper frame.

7. The tablet PC case with built-in printer of claim 6, wherein the hinge connection between the cover and the upper frame is of folding-hinge type, wherein either end of the back side of the cover is provided with an arm extension on which there is a hinge recess, either end of the back side of the upper frame is provided with a lug on which there is a hinge protruding part, and the hinge recess perfectly matches with the hinge protruding part.
